(19) United States
(12) Patent Application Publication
(10) Pub. No.: US 2014/0115471 A1
(43) Pub. Date: Apr. 24, 2014

(54) Importing and Exporting Custom Metadata for a Media Asset

(71) Applicant: APPLE INC., Cupertino, CA (US)

(72) Inventors: Andrew Scott Demkin, San Carlos, CA (US); Peter Alan Steinauer, San Francisco, CA (US)

(73) Assignee: APPLE INC., Cupertino, CA (US)

(21) Appl. No.: 13/788,176

(22) Filed: Mar. 7, 2013

Related U.S. Application Data
(60) Provisional application No. 61/717,027, filed on Oct. 22, 2012.

(51) Int. Cl. G06F 3/048

(52) U.S. Cl. CPC G06F 3/048
USPC 715/719

(57) ABSTRACT

In some implementations, metadata for a media asset can be imported to and/or exported from a media editing application. The metadata can include metadata fields that are predefined for the media editing application. The metadata can include metadata fields that are custom or user-defined or user-generated data fields. Graphical user interfaces of the media editing application can provide mechanisms to allow a user to define new metadata fields. Graphical user interfaces of the media editing application can provide mechanisms to allow a user to view imported metadata fields that were defined externally to the media editing application.

### CROSS REFERENCE TO RELATED APPLICATIONS

This application is a non-provisional of and claims priority to U.S. Provisional Patent Application No. 61/717,027, filed on Oct. 22, 2012, the entire contents of which are hereby incorporated by reference.

### TECHNICAL FIELD

The disclosure generally relates to video editing.

### BACKGROUND

Media editing applications allow a user to create, modify or combine media assets (e.g., music, video, pictures, other media files, etc.) to create a media project. Often the media assets have associated metadata (e.g., name, size, location, etc.) that describes properties of the media asset. Sometimes users share media assets and/or media projects with other users. Thus, asset metadata may need to be exported or imported with a shared media asset or media project.

### SUMMARY

In some implementations, metadata for a media asset can be imported to and/or exported from a media editing application. The metadata can include metadata fields that are predefined for the media editing application. The metadata can include metadata fields that are custom or user-defined or user-generated data fields. Graphical user interfaces of the media editing application can provide mechanisms to allow a user to define new metadata fields. Graphical user interfaces of the media editing application can provide mechanisms to allow a user to view imported metadata fields that were defined externally to the media editing application.

Particular implementations provide at least the following advantages: Users can define custom metadata fields that suit individual media projects or media assets. Users can export the user-defined metadata fields so that other users can view and use the user-defined metadata fields. Users can import, use and view metadata fields defined by other users. The media editing application can automatically update user interfaces to accommodate or display externally defined metadata fields and the data associated with the metadata fields.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example graphical user interface for viewing metadata associated with a media asset.

FIG. 2 illustrates an example graphical user interface for changing displayed metadata fields.

FIG. 3 illustrates an example graphical user interface for editing a metadata view.

FIG. 4 illustrates an example graphical user interface for filtering metadata fields by source.

FIG. 5 illustrates example graphical user interfaces and for creating a custom metadata field.

FIG. 6 illustrates example graphical user interfaces for presenting custom or user-defined metadata fields.

FIG. 7 illustrates an example graphical user interface for adding a custom metadata field.

FIG. 8 illustrates an example graphical user interface for exporting metadata associated with a media asset or media project.

FIGS. 9 and 10 illustrate graphical user interfaces for presenting imported metadata fields for an imported media asset.

FIG. 11A is flow diagram of an example process for generating and exporting custom metadata for a media asset or media project.

FIG. 11B is a flow diagram of an example process for importing custom or externally defined metadata for a media asset or media project.

FIG. 12 is a block diagram of an exemplary system architecture implementing the features and processes of FIGS. 1-11.

Like reference symbols in the various drawings indicate like elements.

### DETAILED DESCRIPTION

This disclosure describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radial buttons, checkboxes and any other mechanism for receiving input from, or providing feedback to a user.

### Viewing Media Asset Metadata

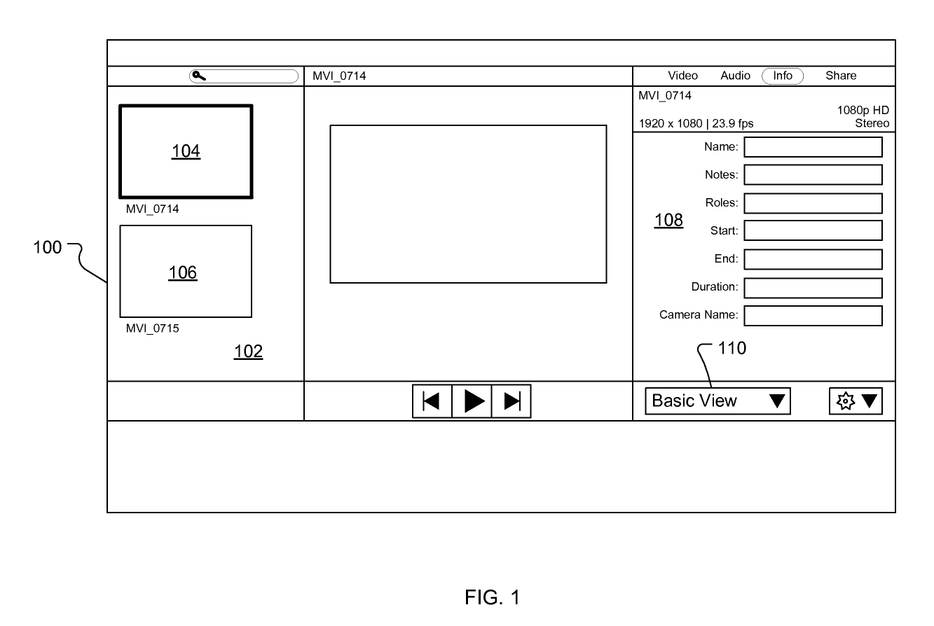

FIG. 1 illustrates an example graphical user interface 100 for viewing metadata associated with a media asset. For example, graphical user interface 100 can be an interface of a media editing application. A media asset can be a video clip, audio clip, picture or any type of media file. In some implementations, graphical user interface 100 can include an area 102 for viewing media assets 104 and 106. For example, a user can browse and select a media asset to work with from the assets presented in area 102. A user can select media asset 104, for example, to view metadata associated with media asset 104.

In some implementations, graphical user interface 100 can include an area 108 for viewing metadata associated with a media asset. For example, a user can select media asset 104 to view metadata associated with media asset 104 and the metadata for media asset 104 can be presented in area 108. In some implementations, a user can view and/or edit values for metadata fields presented in area 108 by providing input to a text input box, pull down menu, radio button or other input mechanism displayed in area 108 and associated with each metadata field. Thus, each metadata field can have an associated value.

In some implementations, the metadata presented in area 108 can correspond to a subset, grouping or view. For example, there can be fifty metadata fields for tracking data associated with a media asset. However, it may be more useful to a user to view a subset (e.g., less than all, some portion) of the metadata fields when working with a media asset. Thus, the media editing application can include predefined subsets or views of metadata fields that the user can select to view a portion of the metadata associated with a media asset.

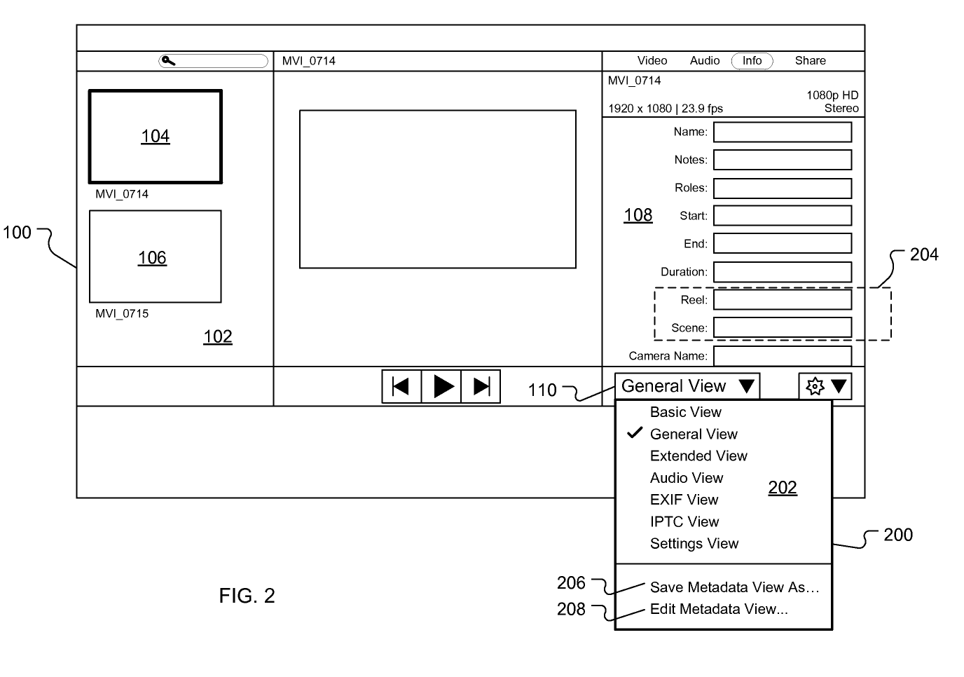

In some implementations, graphical user interface 100 can include selectable graphical object 110 for presenting a list of available views. For example, graphical object 110 can display the name of the currently displayed metadata view (e.g., “Basic View). A user can select graphical object 110 to display the metadata views available in the media editing application or associated with the selected media asset, as described with reference to FIG. 2.

FIG. 2 illustrates an example graphical user interface 200 for changing the displayed metadata fields. For example, graphical user interface 200 can be presented in response to the user selecting graphical object 110 of FIG. 1. In some implementations, a user can change the metadata displayed in area 108 by selecting a view (e.g., “General View”) from metadata view list 202. For example, different metadata views can be associated with different metadata fields. In some implementations, different metadata views can have some or all of the fields of another metadata view. For example, the “General View” displayed on graphical user interface 200 includes the metadata fields from the “Basic View” and includes additional metadata fields 204.

In some implementations, graphical user interface 200 can allow a user to create a new metadata view. For example, graphical user interface 200 can display menu item 206. The user can select menu item 206 to save the current metadata view (e.g., “General View”) as a new metadata view having a user-specified name. For example, in response to the selection of menu item 206, a graphical interface can be displayed that allows the user to specify a name (e.g., “User View”) for a new metadata view having the same metadata fields as the currently displayed metadata view (e.g., “General View”).

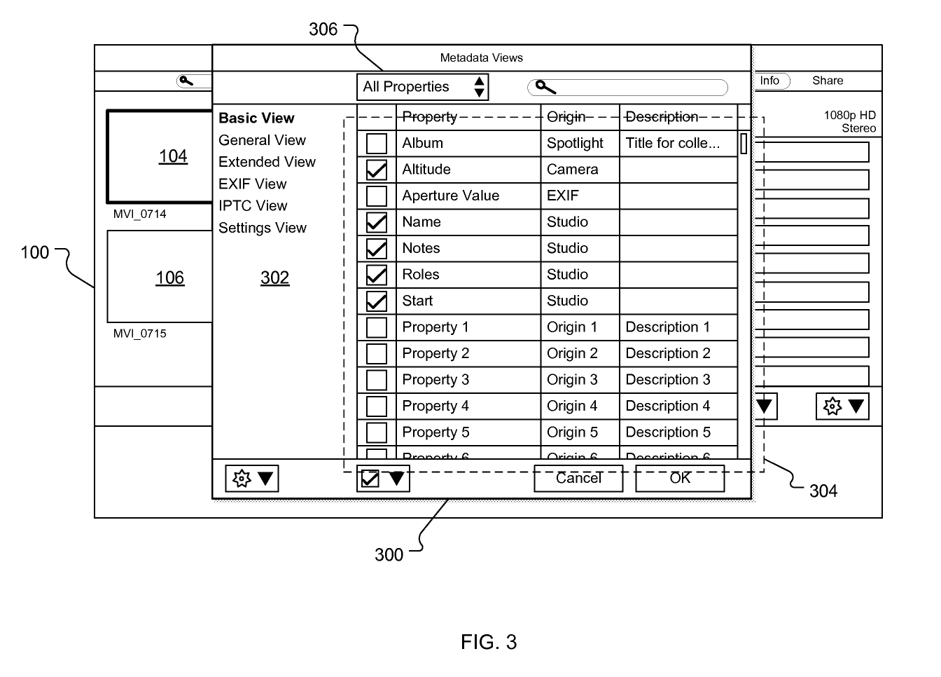

In some implementations, graphical user interface 200 can allow a user to edit an existing metadata view. For example, a user can select menu item 208 from graphical user interface 200 to display a user interface for editing a metadata view, as described with reference to FIG. 3.

FIG. 3 illustrates an example graphical user interface 300 for editing a metadata view. For example, graphical user interface 300 can be displayed in response to selection of menu item 208 of FIG. 2. In some implementations, graphical user interface 300 can present the metadata views 302 currently available in the media editing application. A user can select a metadata view (e.g., “Basic View”) to view metadata fields 304 associated with the selected metadata view. For example, graphical user interface 300 can present metadata fields (i.e., properties) available in the media editing application. Each metadata field can be associated with a view, an origin or source, and a description. The name of the metadata field, the source of the metadata field and the description of the metadata field can be displayed on graphical user interface 300. When the user selects a view (e.g., “Basic View”), graphical user interface 300 will indicate which metadata fields are currently associated with the selected view. For example, metadata fields that have checked checkboxes are associated with the selected view. Metadata fields that do not have checked checkboxes are not associated with the selected metadata view.

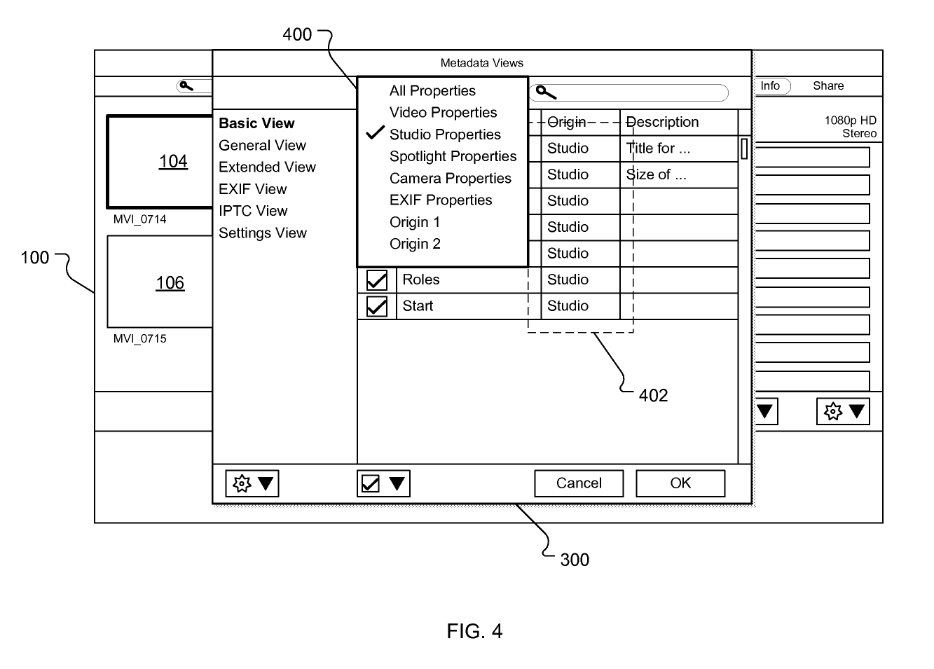

In some implementations, a user can add or remove a metadata field to or from a metadata view. For example, a user can add a metadata field to a selected view by selecting (e.g., checking the checkbox of) a metadata field displayed in graphical user interface 300 that is not currently associated with the selected view. For example, the metadata field “Album” is not currently associated with the metadata view “Basic View.” A user can add the metadata field “Album” to “Basic View” by checking the checkbox associated with the “Album” field. A user can remove a metadata field from a selected view by selecting (e.g., unchecking) a metadata field that is currently associated with the selected view. In some implementations, the user can filter which metadata fields (i.e., properties) are displayed in graphical user interface 300 by selecting graphical object 306. For example, graphical object 306 can be selected to display a pull down menu that allows the user to filter the displayed metadata properties by source, as described with reference to FIG. 4.

FIG. 4 illustrates an example graphical user interface 400 for filtering metadata fields by source. For example, each metadata field (i.e., property) can be associated with a source or origin 402. The source or origin can be associated with a device (e.g., a camera), a computer function that uses the property (e.g., spotlight) or an entity that created the property (e.g., a user, company, etc.). A user can select a source or origin (e.g., “Studio Properties”) from graphical user interface 400 to show only the metadata fields associated with the selected source. For example, as illustrated by FIG. 4, the “Studio Properties” source is selected (e.g., checked) in graphical user interface 400 and only the metadata fields associated with the “Studio” source or origin 402 are displayed on graphical user interface 300.

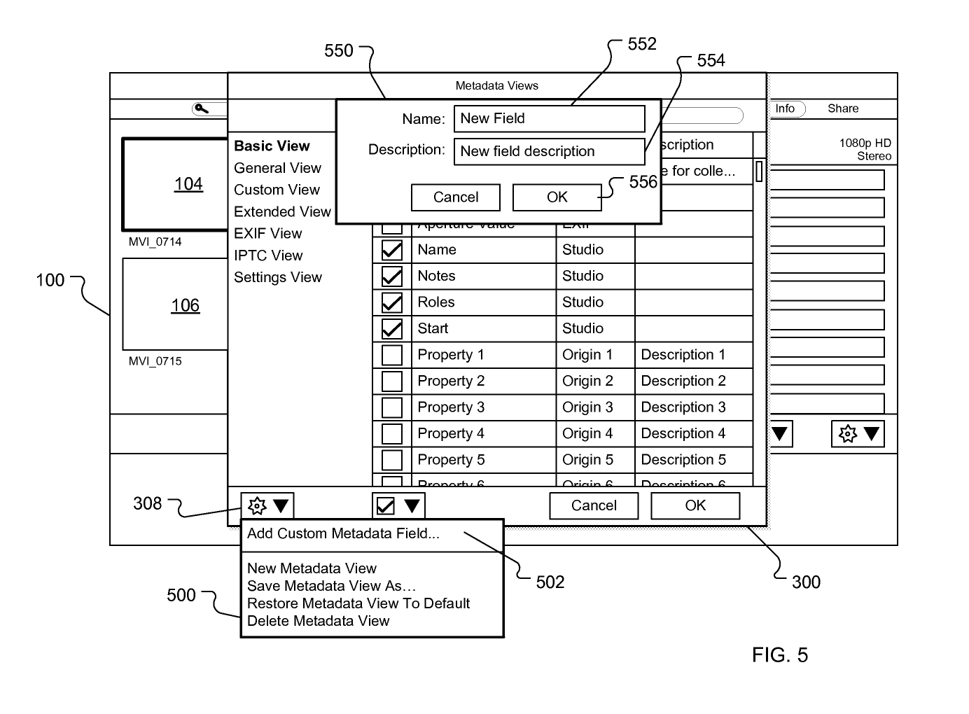

FIG. 5 illustrates example graphical user interfaces 500 and 550 for creating a custom metadata field. In some implementations, a user can select graphical object 308 to cause graphical user interface 500 to display. For example, graphical user interface 500 can be a pull down menu that displays options for editing metadata views and adding a custom metadata field.

In some implementations, a user can create a user-defined or custom metadata fields. For example, the user can select menu item 502 to cause graphical user interface 550 to be displayed. Graphical user interface 550 can include an input field 552 that allows a user to specify a name for a user-defined or custom metadata field. Graphical user interface 550 can include an input field 554 that allows a user to provide a description for the user-defined or custom metadata field. Graphical user interface 550 can include an input field (not shown) that allows a user to specify the source or origin of the user-defined or custom metadata field. If no origin is specified, the user-defined or custom metadata field can be assigned a default origin value (e.g., “Custom,” “Custom Properties,” “User Properties,” etc.). Once the user has provided a name, description and/or origin for the user-defined or custom metadata field, the custom metadata field can be added to the list of metadata fields available in the media editing application. For example, a user can select graphical object 556 to add the custom or user-defined metadata field to the metadata fields available in the media editing application.

In some implementations, the user can select to create a new metadata view by selecting a menu item from graphical user interface 500. For example, the user can create a new view “Custom View” and associate the newly added custom metadata field to the new “Custom View.”

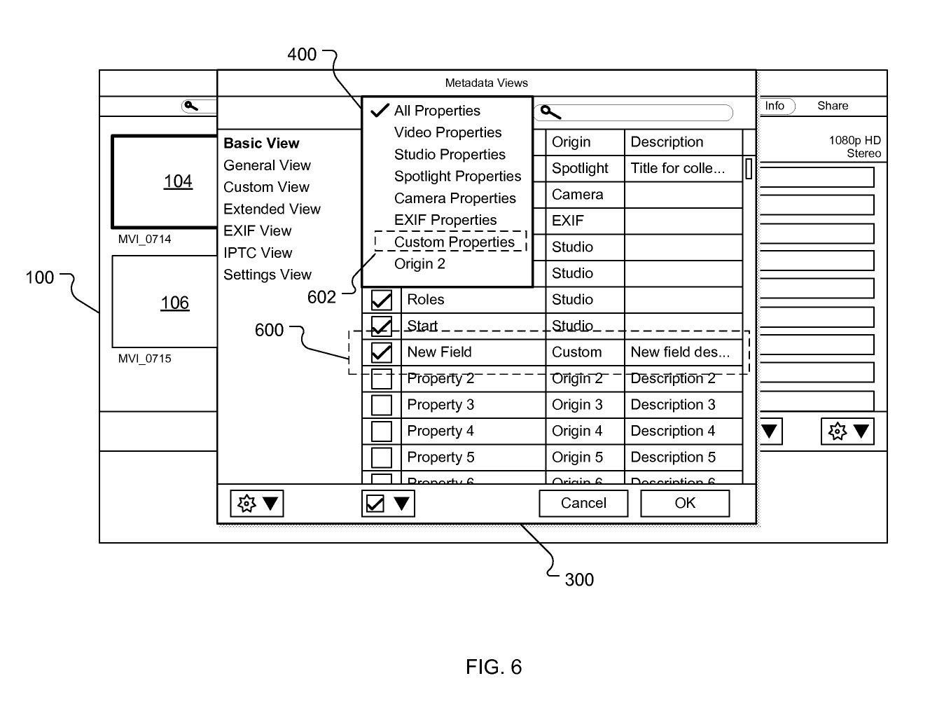

FIG. 6 illustrates example graphical user interfaces 300 and 400 for presenting custom or user-defined metadata fields. In some implementations, graphical user interfaces 300 and/or 400 can present the custom or user-defined metadata fields created when a user interacts with graphical user interfaces 500 and 550, above. For example, a user can create a custom metadata field named “New Field” having a “Custom” origin and a “New field description” description. The custom metadata field can be associated with a predefined metadata view (e.g., “Basic View”) metadata view or a user-defined metadata view (e.g., “Custom View”), as described above.

In some implementations, graphical user interface 300 can display information related to the custom or user-defined metadata fields. For example, graphical interface 300 can present metadata field information including information 600 associated with the user-defined metadata field. User-defined metadata field information 600 can include the name of the user-defined metadata field (“New Field”), the origin of the user-defined metadata field (“Custom”) and a description for the user-defined metadata field (“New field description”).

In some implementations, graphical user interface 400 can allow a user to filter the metadata fields presented in graphical interface 300 by the origin or source of the user-defined metadata fields. For example, graphical user interface 400 can present an identifier 602 (e.g., “Custom Properties”) for the origin or source of the user-defined metadata fields. A user can select the “Custom Properties” identifier to cause graphical user interface 300 to display only the metadata fields that are associated with the “Custom” (e.g., user-defined) source.

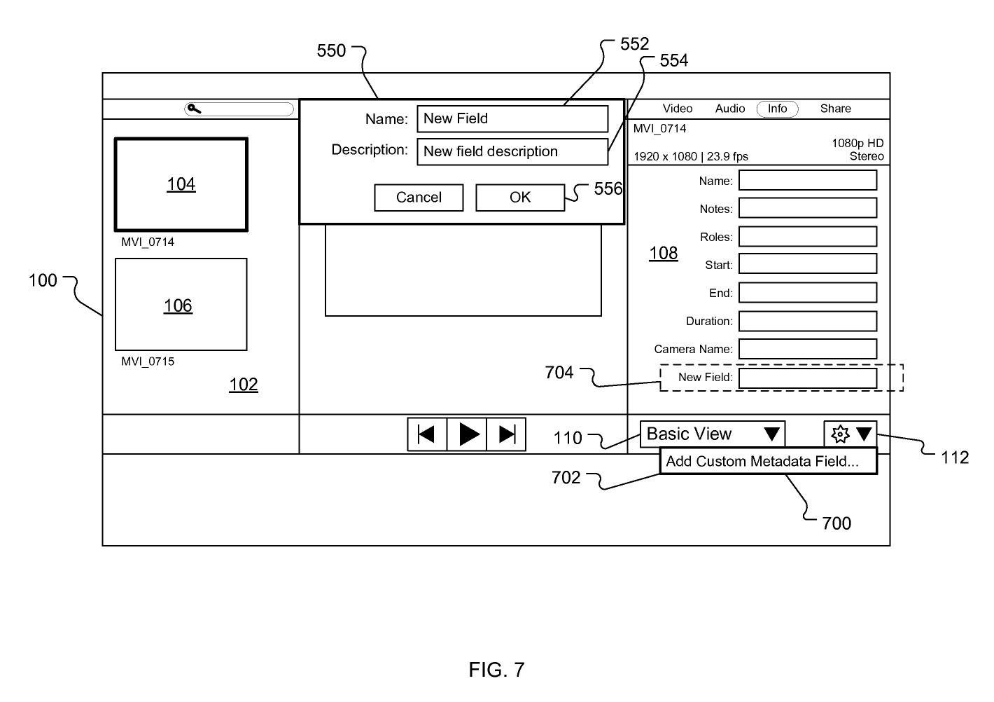

FIG. 7 illustrates an example graphical user interface 700 for adding a custom metadata field to the metadata fields of the media editing application. In some implementations, a user can select graphical object 112 on graphical user interface 100 (e.g., pull down menu) to display graphical user interface 700. When selected, menu item 702 of graphical user interface 700 can cause graphical user interface 550 to be displayed. Graphical user interface 550 can allow the user to specify a user-defined metadata field as described above with reference to FIG. 5. Once the user-defined metadata field has been created, the user-defined metadata field and its associated value 704 can be displayed in area 108 of graphical user interface 100. In some implementations, a user can specify a value for the new user-defined metadata field by providing input to a textual input box, pull down menu, radio button or other input mechanism displayed in area 108 and associated with new user-defined metadata field 704.

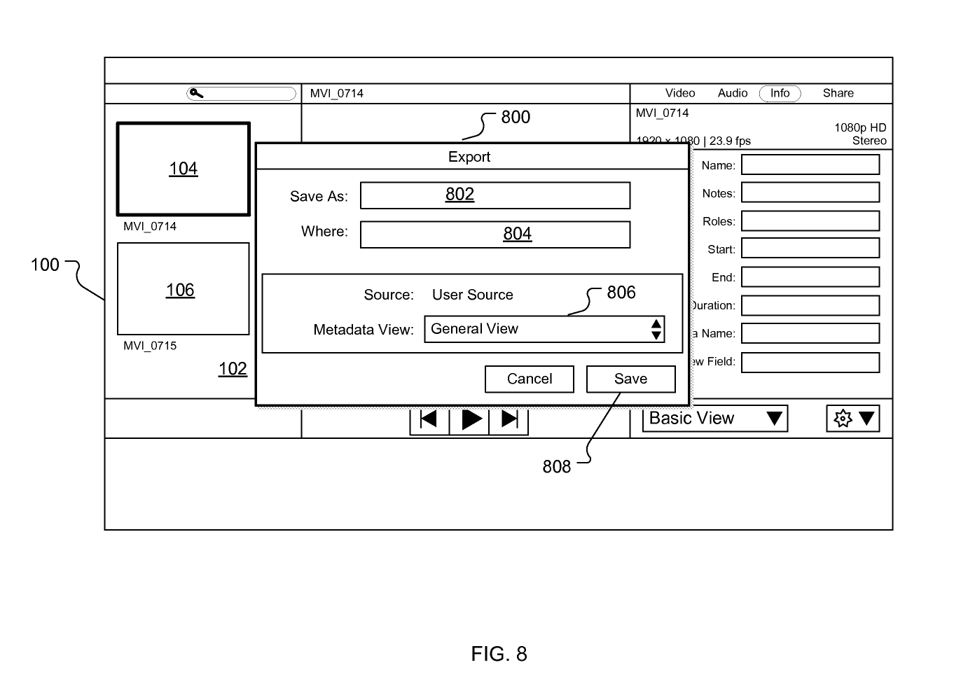

FIG. 8 illustrates an example graphical user interface 800 for exporting metadata associated with a media asset or media project. For example, graphical user interface 800 can be invoked by a user selecting an export menu item from a pull down menu, tool bar or other graphical object associated with the media editing application. In some implementations, graphical user interface 800 can be used to export a file containing predefined and/or user-defined metadata fields and their associated data. For example, a user can provide input to graphical object 802 to specify a name for the exported metadata file. The user can provide input to graphical object 804 to specify a location where the exported metadata file should be saved.

In some implementations, a user can select a metadata view to export from the media editing application. For example, a user may not wish to export all metadata associated with a media asset or media project. The user may wish to only export a subset of the media asset or media project metadata. Thus, in some implementations, graphical user interface 800 can present graphical object 806 that allows a user to select a metadata view to export. For example, graphical object 806 can be pull-down menu that allows the user to select a metadata view (e.g., a predefined metadata view or a user-defined metadata view) to export. When a metadata view is selected, the metadata fields and the data associated with the metadata fields (e.g., origin, description, value, views, etc.) can be exported and saved to the metadata export file in response to the user selecting graphical object 808.

In some implementations, exported media asset and/or media project metadata (e.g., including user-defined metadata) can be exported to an XML (extensible markup language) formatted file. For example, the metadata fields and associated data can be written to the file as an XML element having properties corresponding to the metadata fields and associated data. For example, the XML file can have a metadata element <md> that includes the properties “key,” “value,” “type,” “source,” “displayName,” “description” and “editable.” The property “key” can have a value that is a unique identifier for the metadata field. For example, the key's value can be a string such as “us.company.product.fieldname” (e.g., <md key=“us.company.product.fieldname”/>). The property “value” can indicate the value associated with the metadata field (e.g., (e.g., <md . . . value=“My Project”/>). The property “type” can indicate the data type of the value property (e.g., <md . . . type=“string”/>). The “source” property can indicate the source of the metadata field (e.g., <md . . . source=“company name”/>). The “displayName” property can indicate the display name for the metadata field (e.g., <md displayName=“Field Name”/>). For example, the display name can be the name of the metadata field that should be displayed on the media editing application's user interfaces. The “description” property can provide a description for the metadata field (e.g., <md description=“Field description”/>). The “editable” property can indicate whether the value of the metadata field is editable. For example, the editable property can indicate whether the user can edit the value of the metadata field in area 108 of graphical user interface 100 (e.g., <md editable=“0”/>, where 1=yes, 0=no).

The following is an example portion of an XML formatted metadata export file that includes predefined metadata fields (e.g., us.company.studio.name) and user-defined metadata fields (e.g., us.user.defined.newField):

```
<?xml version=″1.0″ encoding=″UTF-8″ standalone=″no″?>
<!DOCTYPE fcpxml>
<fcpxml version=″1.2″>
  <project name=″Project 1″>
    <resources>
      <format/>
      <asset name=”MVI_0714”>
        <metadata>
          <md key=″us.company.studio.name″
                value=″Some Name″
                type=″string″
                source=″Studio ″
                displayName=″Name″
                description=””
                editable=″0″/>
          <md key=″us.user.custom.newField″
                value=″37″
                type=″integer″
                source=″custom ″
                displayName=″New Field″
                description=”This is a new field for ...”
                editable=″0″/>
          <md key=″us.company.imported.property1″
                value=″42″
                type=″string″
                source=″Imported″
                displayName=″Property 1″
                description=”Imported property description...”
                editable=″1″/>
        </metadata>
      </asset>
    </resources>
    <clip name=″MVI_0714″ duration=″158158/24000 (6.58992)s″
start=″33498465/24000 (1395.77)s″ format=″r1″ tcFormat=″NDF″>
    </clip>
  </project>
</fcpxml>
```

In some implementations, a user can import a metadata file into the media editing application. For example, the user can import a file containing metadata for a media asset and/or project. The file can include predefined metadata fields (e.g., fields preconfigured with the media application). The file can include user-defined metadata fields (e.g., metadata fields defined by the user via the user interfaces above).

In some implementations, the file can include externally defined metadata fields. For example, an externally defined metadata field can be a field defined by another instance of the media editing application or defined by a user, entity, company, etc., other than the user, entity, company, etc. that imported the file. The user-defined metadata fields and the externally defined metadata fields can be metadata fields that are not configured or known to the media editing application before importing the metadata file. Thus, the media editing application can automatically update user interfaces to accommodate or display externally defined metadata fields and the data associated with the metadata fields. In some implementations, the imported metadata file can be an XML formatted file that includes XML tags, elements and/or properties similar to the XML described above.

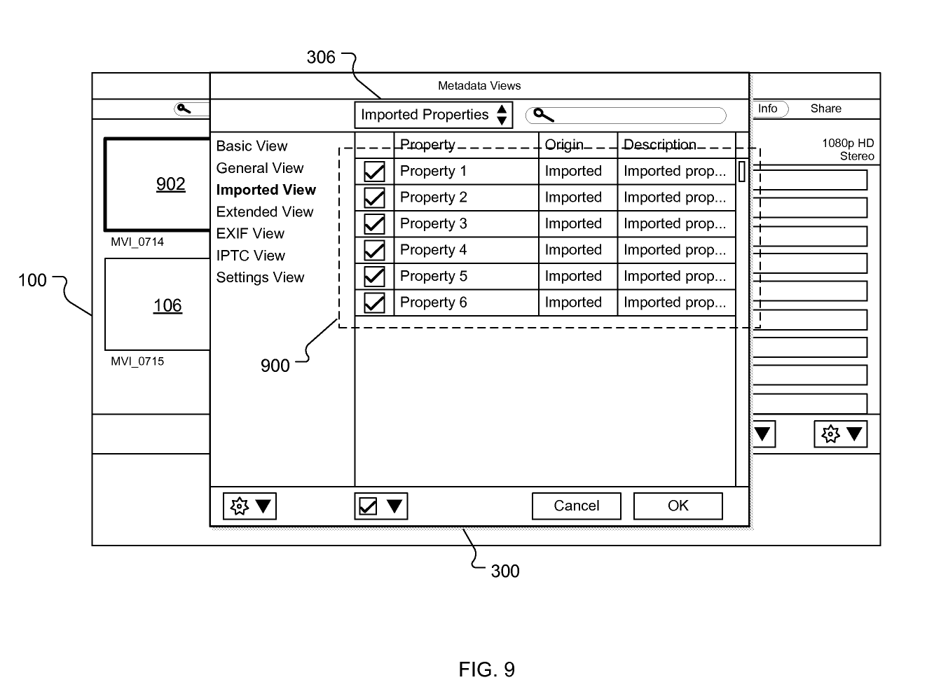

FIG. 9 illustrates graphical user interface 300 for presenting imported metadata fields 900 for imported media asset 902. For example, a user can select a menu item (not shown) to import a metadata file that includes imported metadata fields 900. The user can select imported media asset 902 to view metadata associated with the imported media asset, as described above. The user can invoke graphical user interface 300 to view the metadata fields 900, as describe above with reference to FIG. 3. Metadata fields 900 can include predefined, user-defined and/or externally defined metadata fields. Metadata fields 900 can be associated with a source or origin (e.g., “Imported,” or “Imported Properties”) and can be filtered based on the origin by selecting the origin from graphical object 306, as described above with reference to FIG. 3.

In some implementations, the imported metadata fields 900 can be associated with a view. For example, a user can add the imported metadata fields to a predefined metadata view (e.g., “Basic View”). The user can add the imported metadata fields to a user-defined (e.g., custom) view (e.g., “Imported View”), as described above.

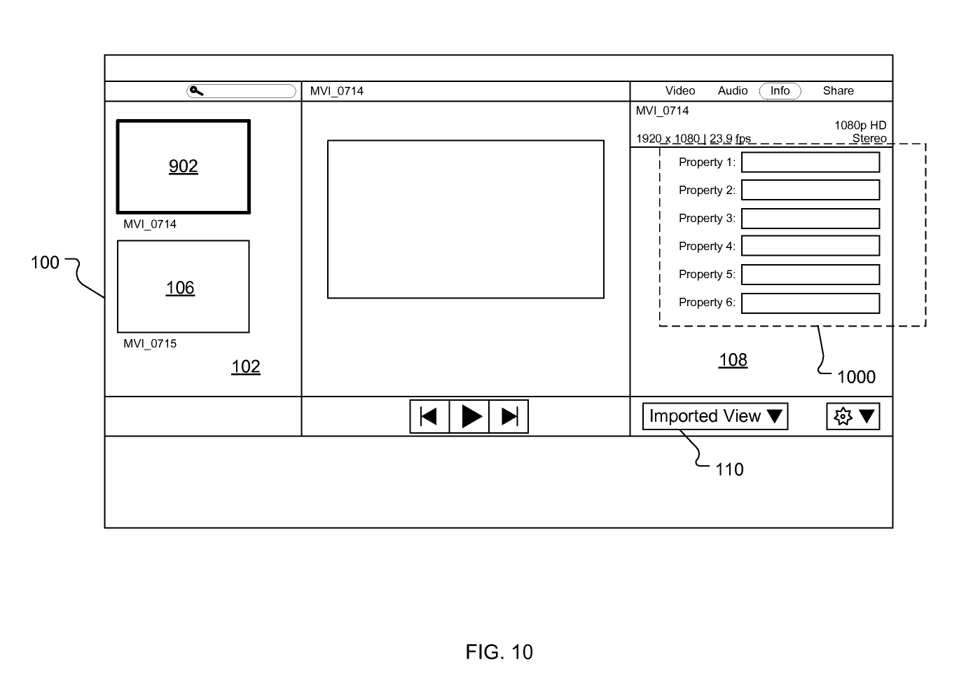

FIG. 10 illustrates graphical user interface 100 presenting imported metadata fields 1000. For example, metadata fields 1000 can be imported from an XML formatted metadata file that defines metadata fields and/or values for a media asset (e.g., imported media asset 902) and/or media project. Metadata fields 1000 can correspond to imported metadata fields 900, for example. Metadata fields 1000 can be viewed by selecting media asset 902 with which metadata fields 1000 are associated. A user can view and/or edit values associated with metadata fields 1000, as described above with reference to FIG. 1.

### Example Processes

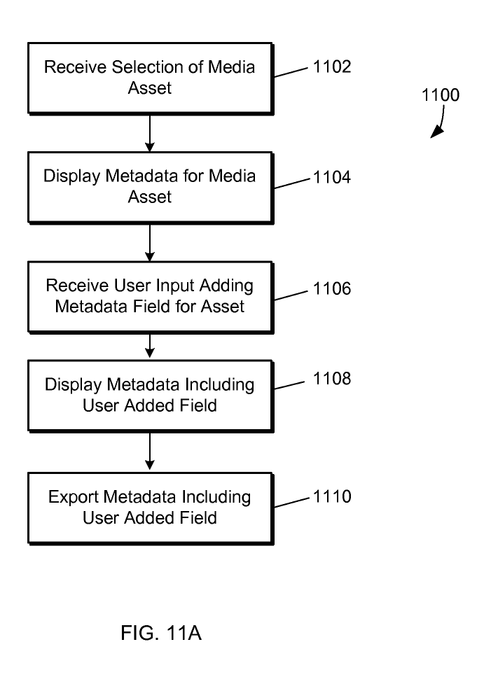

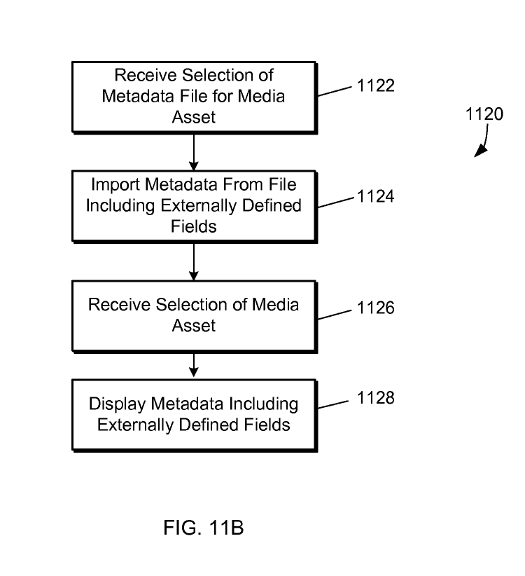

FIG. 11A is flow diagram of an example process 1100 for generating and exporting custom metadata for a media asset or media project. At step 1102, a selection of a media asset is received. For example, a media editing application can present graphical user interfaces that allow a user to view and interact with media assets. A user can select a media asset displayed on a graphical user interface of the media editing application.

At step 1104, metadata for the media asset can be displayed. For example, metadata fields, values, descriptions, origin (i.e., source), etc. can be displayed for the selected media asset, as described above with reference to FIGS. 1-4.

At step 1106, user input for adding a new or custom metadata field for a media asset can be received. For example, the user can create new, custom, or user-defined metadata fields, as described above with reference to FIGS. 5 and 7.

At step 1108, metadata including the user added custom metadata fields can be displayed. For example, the custom or user-defined metadata fields can be displayed on a user interface of the media editing application as described above with reference to FIGS. 6 and 7.

At step 1110, the metadata for a media asset or media project, including the added user-defined or custom metadata fields, can be exported from the media editing application. For example, the predefined and/or user defined metadata for a media asset or media project can be exported to an XML formatted metadata file, as described above with reference to FIG. 8.

FIG. 11B is a flow diagram of an example process 1120 for importing custom or externally defined metadata for a media asset or media project. At step 1122, a selection of a metadata file for a media asset or media project can be received by a media editing application. For example, the user can invoke an import file function of the media editing application and an import file selection window can be displayed that allows the user to select a metadata file to import.

At step 1124, the selection metadata file can be imported, including externally defined metadata fields. For example, externally defined metadata fields can be metadata fields that are defined by another instance of the media editing application or a user, entity, company, etc. other than the user, entity, company, etc. importing the metadata file into the media editing application. Externally defined metadata fields can be metadata fields that are not predefined within the media editing application.

At step 1126, a selection of a media asset can be received by the media editing application. For example, the user can select an imported media asset, as described above with reference to FIG. 9.

At step 1128, the imported metadata, including the externally defined metadata fields, can be displayed. For example, the imported metadata can be presented on a user interface of the media editing application, as described above with reference to FIGS. 9 and 10.

### Example System Architecture

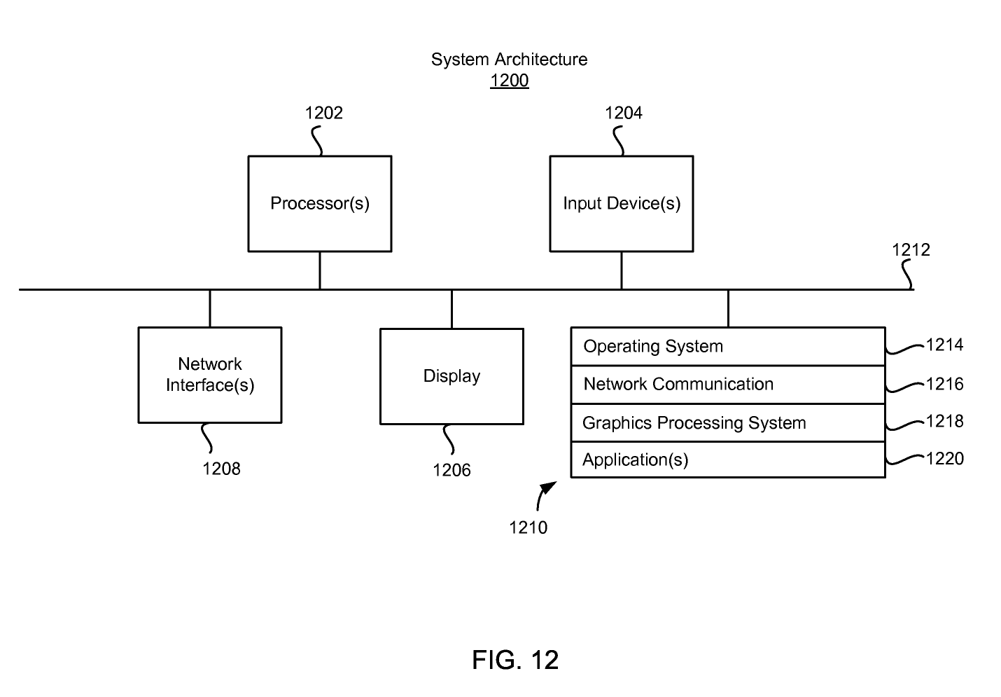

FIG. 12 is a block diagram of an exemplary system architecture implementing the features and processes of FIGS. 1-11. The architecture 1200 can be implemented on any electronic device that runs software applications derived from compiled instructions, including without limitation personal computers, servers, smart phones, media players, electronic tablets, game consoles, email devices, etc. In some implementations, the architecture 1200 can include one or more processors 1202, one or more input devices 1204, one or more display devices 1206, one or more network interfaces 1208 and one or more computer-readable mediums 1210. Each of these components can be coupled by bus 1212.

Display device 1206 can be any known display technology, including but not limited to display devices using Liquid Crystal Display (LCD) or Light Emitting Diode (LED) technology. Processor(s) 1202 can use any known processor technology, including but are not limited to graphics processors and multi-core processors. Input device 1204 can be any known input device technology, including but not limited to a keyboard (including a virtual keyboard), mouse, track ball, and touch-sensitive pad or display. Bus 1212 can be any known internal or external bus technology, including but not limited to ISA, EISA, PCI, PCI Express, NuBus, USB, Serial ATA or FireWire. Computer-readable medium 1210 can be any medium that participates in providing instructions to processor(s) 1202 for execution, including without limitation, non-volatile storage media (e.g., optical disks, magnetic disks, flash drives, etc.) or volatile media (e.g., SDRAM, ROM, etc.).

Computer-readable medium 1210 can include various instructions 1214 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 1204; sending output to display device 1206; keeping track of files and directories on computer-readable medium 1210; controlling peripheral devices (e.g., disk drives, printers, etc.) which can be controlled directly or through an I/O controller; and managing traffic on bus 1212. Network communications instructions 1216 can establish and maintain network connections (e.g., software for implementing communication protocols, such as TCP/IP, HTTP, Ethernet, etc.). A graphics processing system 1218 can include instructions that provide graphics and image processing capabilities. For example, the graphics processing system 1218 can implement the processes described with reference to FIGS. 1-11.

Application(s) 1220 can be an application that uses or implements the processes described in reference to FIGS. 1-11. For example, applications 1220 can include the media editing application described above. The processes can also be implemented in operating system 1214.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
presenting metadata fields associated with a media asset on a display of a computing device, the metadata fields including one or more predefined metadata fields;
receiving input specifying a user-defined metadata field for the media asset;
displaying the user-defined metadata field with the metadata fields associated with the media asset;
receiving input for exporting the metadata fields; and
exporting the metadata fields, including the user-defined metadata field.

2. The method of claim 1, where a subset of the metadata fields are associated with a metadata view and wherein receiving input for exporting the metadata fields comprises:
receiving input selecting the metadata view; and
exporting the subset of the metadata fields associated with the selected metadata view.

3. The method of claim 1, where exporting the metadata fields includes saving the predefined metadata fields and the user-defined metadata fields to a file.

4. The method of claim 1, further comprising:
receiving a selection of a category; and
filtering the metadata fields presented on the display based on the selected category.

5. A method comprising:
presenting a user interface of a media editing application on a display of a computing device;
receiving user input selecting a metadata file including metadata for a media asset, the asset metadata including predefined and externally defined metadata fields;
importing the metadata in the metadata file into the media editing application; and
displaying the predefined and externally defined metadata fields on the user interface of the media editing application.

6. The method of claim 5, where the media editing application is preconfigured with predefined metadata fields.

7. The method of claim 5, where the media editing application is not preconfigured with externally defined metadata fields.

8. The method of claim 5, where displaying the predefined and externally defined metadata fields on the user interface of the media editing application includes automatically updating the user interface to accommodate the externally defined metadata fields.

9. A non-transitory computer-readable medium including one or more sequences of instructions which, when executed by one or more processors, causes:
presenting metadata fields associated with a media asset on a display of a computing device, the metadata fields including one or more predefined metadata fields;
receiving input specifying a user-defined metadata field for the media asset;
displaying the user-defined metadata field with the metadata fields associated with the media asset;
receiving input for exporting the metadata fields; and
exporting the metadata fields, including the user-defined metadata field.

10. The non-transitory computer-readable medium of claim 9, where a subset of the metadata fields are associated with a metadata view and wherein the instructions for receiving input for exporting the metadata fields include instructions for:
receiving input selecting the metadata view; and
exporting the subset of the metadata fields associated with the selected metadata view.

11. The non-transitory computer-readable medium of claim 9, wherein the instructions for exporting the metadata fields include instructions for saving the predefined metadata fields and the user-defined metadata fields to a file.

12. The non-transitory computer-readable medium of claim 9, wherein the instructions include:
receiving a selection of a category; and
filtering the metadata fields presented on the display based on the selected category.

13. A non-transitory computer-readable medium including one or more sequences of instructions which, when executed by one or more processors, causes:
presenting a user interface of a media editing application on a display of a computing device;
receiving user input selecting a metadata file including metadata for a media asset, the asset metadata including predefined and externally defined metadata fields;
importing the metadata in the metadata file into the media editing application; and
displaying the predefined and externally defined metadata fields on the user interface of the media editing application.

14. The non-transitory computer-readable medium of claim 13, where the media editing application is preconfigured with predefined metadata fields.

15. The non-transitory computer-readable medium of claim 13, where the media editing application is not preconfigured with externally defined metadata fields.

16. The non-transitory computer-readable medium of claim 13, wherein the instructions for displaying the predefined and externally defined metadata fields on the user interface of the media editing application include instructions for automatically updating the user interface to accommodate the externally defined metadata fields.

17. A system comprising:
one or more processors; and
a computer-readable medium including one or more sequences of instructions which, when executed by the one or more processors, causes:
presenting metadata fields associated with a media asset on a display of a computing device, the metadata fields including one or more predefined metadata fields;
receiving input specifying a user-defined metadata field for the media asset;
displaying the user-defined metadata field with the metadata fields associated with the media asset;
receiving input for exporting the metadata fields; and
exporting the metadata fields, including the user-defined metadata field.

18. The system of claim 17, where a subset of the metadata fields are associated with a metadata view and wherein the instructions for receiving input for exporting the metadata fields include instructions for:
receiving input selecting the metadata view; and
exporting the subset of the metadata fields associated with the selected metadata view.

19. The system of claim 17, wherein the instructions for exporting the metadata fields include instructions for saving the predefined metadata fields and the user-defined metadata fields to a file.

20. The system of claim 17, wherein the instructions include:
receiving a selection of a category; and
filtering the metadata fields presented on the display based on the selected category.

21. A system comprising:
one or more processors; and
a computer-readable medium including one or more sequences of instructions which, when executed by one or more processors, causes:
presenting a user interface of a media editing application on a display of a computing device;
receiving user input selecting a metadata file including metadata for a media asset, the asset metadata including predefined and externally defined metadata fields;
importing the metadata in the metadata file into the media editing application; and
displaying the predefined and externally defined metadata fields on the user interface of the media editing application.

22. The system of claim 21, where the media editing application is preconfigured with predefined metadata fields.

23. The system of claim 21, where the media editing application is not preconfigured with externally defined metadata fields.

24. The system of claim 21, wherein the instructions for displaying the predefined and externally defined metadata fields on the user interface of the media editing application include instructions for automatically updating the user interface to accommodate the externally defined metadata fields.
